(19) United States
(12) Patent Application Publication
(10) Pub. No.: US 2015/0154639 A1
(43) Pub. Date: Jun. 4, 2015

(54) SERVING ADVERTISEMENTS BASED ON USER PHYSICAL ACTIVITY

(71) Applicants: Cedric Dupont, San Francisco, CA (US); Brian Patrick Williams, Mountain View, CA (US)

(72) Inventors: Cedric Dupont, San Francisco, CA (US); Brian Patrick Williams, Mountain View, CA (US)

(73) Assignee: Google Inc., Mountain View, CA (US)

(21) Appl. No.: 13/439,424

(22) Filed: Apr. 4, 2012

(51) Int. Cl. G06Q 30/02; G06Q 10/06

(52) U.S. Cl. CPC G06Q 30/0261; G06Q 30/0255; G06Q 10/067

(57) ABSTRACT

Aspects of the disclosure relate to serving content. In one example, while on a shopping trip at a store, a device may scan for wireless network access point information. The scanned information may be compared to a location model store to determine the device's location in the store and how the device is moving through the store. This information may be compared to behavior models. In one example, identifying a behavior model may include comparing the average speed of the device to a single threshold value (faster or slower than this speed?), by comparing the behaviors of the device to a set of pre-determined behavior models (the browser, the list-follower, the single-item purchaser), or by comparing to the device's shopping habits. The behavior model may then be used to select and serve content.

### BACKGROUND

Modern mobile devices are equipped with location-based features. Content systems, such as advertisement systems, have used positioning technologies to provide location-based information and advertising to the mobile devices. For instance, some systems have used GPS technologies to locate a mobile device and provide location specific information to the mobile user such as airline and traffic information. Other systems have utilized GPS technologies to locate a mobile device and provide local advertisements to the user.

However, systems as such typically depend heavily on the strength of GPS satellite signals to detect location of the mobile device. Unfortunately, in locations where the GPS satellite signals are weak or not detected, e.g., when the mobile devices are indoors, these systems may not function properly.

Further, even if the systems provide location-based information or location-based advertisements to the mobile device, that information may not be interesting to the user, unless the systems specifically solicit or inquire about the user's areas of interest beforehand. However, a user may be reluctant to answer such inquiries. Even if the user chooses to answer the inquiries for the time being, the same user may change his/her interests from time to time, or may have current interests different from his/her typical areas of interest, making it difficult for the systems to stay updated with the user's interests as of the moment.

### BRIEF SUMMARY

One aspect of the disclosure a method for generating a set of behavior models for a store. The method includes receiving a plurality of time-indexed logs, each time-indexed log of the plurality of being associated with the store and with purchase information describing one or more items purchased by a participant during a shopping trip, and each time-indexed log of the plurality of time-indexed logs including one or more wireless network access point identifiers and signal strengths; identifying a wireless network access point model for the store, the wireless network access point model mapping locations in the store to wireless network access point identifiers and signal strengths; for each given time-indexed log of the plurality of time-indexed logs, determining one or more locations, headings, and speeds based on the wireless network access point model; generating, by a processor, the set of behavior models for the store based on the one or more determined locations, headings, and speeds; for each particular behavior model of the set of behavior models for the store, generating content information for serving content based on the purchase information associated with each log used to generate the particular behavior model; and storing the set of behavior models for the store in memory for later use.

In one example, each of the plurality of time-indexed logs is received from one or more client devices associated with a particular participant, and the method also includes associating the set of behavior models with an account for the particular user. In another example, each time-indexed log of the plurality of time-indexed logs further includes measurements from one or more orientation devices, and determining the locations, headings, and speeds for each given time-indexed log of the plurality of time-indexed logs is also based on the measurements from the one or more orientation devices for the given time-indexed log.

In yet another example, the method also includes receiving a second plurality of time-indexed logs, each time-indexed log of the second plurality being associated with a second store and purchase information describing items purchased by a participant during a shopping trip to the second store, and each time-indexed log of the plurality of second time-indexed logs including one or more wireless network access point identifiers and signal strengths, wherein the second store is different from the store; identifying a second wireless network access point model for the second store, the second wireless network access point model mapping locations in the second store to wireless network access point identifiers and signal strengths; for each given time-indexed log of the plurality of second time-indexed logs, determining one or more second locations, second headings, and second speeds based on the second wireless network access point model; generating a second set of behavior models for the second store based on the one or more determined second locations, second headings, and second speeds; for each given behavior model of the second set of behavior models for the store, generating second content information for serving content based on the second purchase information associated with the time-indexed log or time-indexed logs of the plurality of second time-indexed logs used to generate the given behavior model; and storing the second set of behavior models for the store in the memory for later use. In one alternative to this example, the method also includes receiving, from a first client device, location information; identifying, from the stored sets of behavior models, the second set of behavior models based on the received location information; and identifying the second wireless network access point model based on the received location information. This method may also include receiving, from the first client device, a set of time-indexed log entries including wireless network access point identifiers and signal strengths; after identifying the second wireless network access point model based on the received location information, determining one or more third locations, one or more third headings, and one or more third speeds based on the second wireless network access point model; identifying a most closely matching behavior model of the second set of behavior models based on the determined one or more third locations, one or more third headings, and one or more third speeds; identifying content for display to a user based on the second content information associated with the most closely matching behavior model; and transmitting the identified content to the first client device.

Another aspect of the disclosure provides a method for selecting content based on physical activity associated with a client device. The method includes receiving, from the client device, location information; identifying a set of behavior models from a plurality of stored sets of behavior models based on the received location information, each behavior model of the plurality of behavior models describing behavior of a client device during a shopping event and being associated with content information used to identify content for display to a user; identifying, from a plurality of wireless network access point models, a wireless network access point model based on the received location information, each wireless network access point model of the plurality of wireless network access point models mapping locations in a respective store to wireless network access point identifiers and signal strengths; receiving, from the first client device, a set of time-indexed log entries including one or more wireless network access point identifiers and signal strengths; determining one or more locations, one or more headings, and one or more speeds based on the identified wireless network access point model; selecting, by a processor, a most closely matching behavior model of the second set of behavior models based on the determined one or more locations, one or more headings, and one or more speeds; identifying content for display to a user of the client device based on the second content information associated with the most closely matching behavior model; and transmitting the identified content to the client device.

In one example, identifying the set of behavior models is also based on account information associated with the user of the client device. In another example, identifying the content is further based on account information associated with the user of the client device indicating how much content the user of the client device wants to receive. In yet another example, identifying the content is further based on account information associated with the user of the client device indicating how much content the user of the client device wants to receive. In a further example, after identifying content, generating an advertisement from the identified content and transmitting the advertisement to the client device.

A further aspect of the disclosure provides a device for generating a set of behavior models for a store. The device includes memory storing instructions. The device also includes a processor coupled to the memory. The processor executes the instructions in order to receive a plurality of time-indexed logs, each time-indexed log of the plurality of being associated with the store and with purchase information describing one or more items purchased by a participant during a shopping trip, and each time-indexed log of the plurality of time-indexed logs including one or more wireless network access point identifiers and signal strengths; identify a wireless network access point model for the store, the wireless network access point model mapping locations in the store to wireless network access point identifiers and signal strengths; for each given time-indexed log of the plurality of time-indexed logs, determine one or more locations, headings, and speeds based on the wireless network access point model; generate the set of behavior models for the store based on the one or more determined locations, headings, and speeds; for each particular behavior model of the set of behavior models for the store, generate content information for serving content based on the purchase information associated with each log used to generate the particular behavior model; and store the set of behavior models for the store in the memory for later use.

In one example, each of the plurality of time-indexed logs is received from one or more client devices associated with a particular participant, and the processor further associates the set of behavior models with an account for the particular user. In another example, each time-indexed log of the plurality of time-indexed logs further includes measurements from one or more orientation devices, and wherein the processor further determines the locations, headings, and speeds for each given time-indexed log of the plurality of time-indexed logs is further based on the measurements from the one or more orientation devices for the given time-indexed log.

In yet another example, the processor also executes the instructions in order to receive a second plurality of time-indexed logs, each time-indexed log of the second plurality being associated with a second store and purchase information describing items purchased by a participant during a shopping trip to the second store, and each time-indexed log of the plurality of second time-indexed logs including one or more wireless network access point identifiers and signal strengths, wherein the second store is different from the store; identify a second wireless network access point model for the second store, the second wireless network access point model mapping locations in the second store to wireless network access point identifiers and signal strengths; for each given time-indexed log of the plurality of second time-indexed logs, determine one or more second locations, second headings, and second speeds based on the second wireless network access point model; generate a second set of behavior models for the second store based on the one or more determined second locations, second headings, and second speeds; for each given behavior model of the second set of behavior models for the store, generate second content information for serving content based on the second purchase information associated with the time-indexed log or time-indexed logs of the plurality of second time-indexed logs used to generate the given behavior model; and store the second set of behavior models for the store in the memory for later use. In one alternative to this example, the processor also executes the instructions in order to receive, from a first client device, location information; identify, from the stored sets of behavior models, the second set of behavior models based on the received location information; and identify the second wireless network access point model based on the received location information. The processor may also execute the instructions in order to receive, from the first client device, a set of time-indexed log entries including wireless network access point identifiers and signal strengths; after identifying the second wireless network access point model based on the received location information, determine one or more third locations, one or more third headings, and one or more third speeds based on the second wireless network access point model; identifies a most closely matching behavior model of the second set of behavior models based on the determined one or more third locations, one or more third headings, and one or more third speeds; identify content for display to a user based on the second content information associated with the most closely matching behavior model; transmit the identified content to the first client device.

Another aspect of the disclosure provides a device for selecting content based on physical activity associated with of a client device. The device includes memory storing instructions. The device also includes a processor coupled to the memory. The processor executes the instructions in order to receive, from the client device, location information; identify a set of behavior models from a plurality of stored sets of behavior models based on the received location information, each behavior model of the plurality of behavior models describing behavior of a client device during a shopping event and being associated with content information used to identify content for display to a user; identify, from a plurality of wireless network access point models, a wireless network access point model based on the received location information, each wireless network access point model of the plurality of wireless network access point models mapping locations in a respective store to wireless network access point identifiers and signal strengths; receive, from the first client device, a set of time-indexed log entries including one or more wireless network access point identifiers and signal strengths; determine one or more locations, one or more headings, and one or more speeds based on the identified wireless network access point model; select a most closely matching behavior model of the second set of behavior models based on the determined one or more locations, one or more headings, and one or more speeds; identify content for display to a user of the client device based on the second content information associated with the most closely matching behavior model; and transmit the identified content to the client device.

In one example, the processor also executes the instructions in order to identify the set of behavior models based on account information associated with the user of the client device. In another example, the processor also executes the instructions in order to identify the content based on account information associated with the user of the client device indicating how much content the user of the client device wants to receive. In yet another example, the processor also executes the instructions in order to identify the content based on account information associated with the user of the client device indicating how much content the user of the client device wants to receive. In a further example, the processor also executes the instructions in order to, after identifying content, generate an advertisement from the identified content and transmit the advertisement to the client device.

Yet another aspect of the disclosure provides a tangible, non-transitory computer-readable storage medium on which computer readable instructions of a program are stored. The instructions, when executed by a processor, cause the processor to perform a method of generating a set of behavior models for a store. The method includes receiving a plurality of time-indexed logs, each time-indexed log of the plurality of being associated with the store and with purchase information describing one or more items purchased by a participant during a shopping trip, and each time-indexed log of the plurality of time-indexed logs including one or more wireless network access point identifiers and signal strengths; identifying a wireless network access point model for the store, the wireless network access point model mapping locations in the store to wireless network access point identifiers and signal strengths; for each given time-indexed log of the plurality of time-indexed logs, determining one or more locations, headings, and speeds based on the wireless network access point model; generating the set of behavior models for the store based on the one or more determined locations, headings, and speeds; for each particular behavior model of the set of behavior models for the store, generating content information for serving content based on the purchase information associated with each log used to generate the particular behavior model; and storing the set of behavior models for the store in memory for later use.

A further aspect of the disclosure provides a tangible, non-transitory computer-readable storage medium on which computer readable instructions of a program are stored. The instructions, when executed by a processor, cause the processor to perform a method of selecting content based on physical activity associated with of a client device. The method includes receiving, from the client device, location information; identifying a set of behavior models from a plurality of stored sets of behavior models based on the received location information, each behavior model of the plurality of behavior models describing behavior of a client device during a shopping event and being associated with content information used to identify content for display to a user; identifying, from a plurality of wireless network access point models, a wireless network access point model based on the received location information, each wireless network access point model of the plurality of wireless network access point models mapping locations in a respective store to wireless network access point identifiers and signal strengths; receiving, from the first client device, a set of time-indexed log entries including one or more wireless network access point identifiers and signal strengths; determining one or more locations, one or more headings, and one or more speeds based on the identified wireless network access point model; selecting a most closely matching behavior model of the second set of behavior models based on the determined one or more locations, one or more headings, and one or more speeds; identifying content for display to a user of the client device based on the second content information associated with the most closely matching behavior model; and transmitting the identified content to the client device.

### BRIEF DESCRIPTION OF THE DRAWINGS

FIG. 1 is a functional diagram of a system in accordance with aspects of the technology.

FIG. 2 is a functional diagram of a system in accordance with aspects of the technology.

FIG. 3 is a map of a store in accordance with an aspect of the disclosure.

FIG. 4 is a coordinate map of a wireless network access point model for the store of FIG. 3 in accordance with aspects of the disclosure.

FIG. 5 is data of the wireless network access point model of FIG. 4 in accordance with aspects of the disclosure.

FIG. 6 is a coordinate map of locations of a client device as it moves through a store in accordance with aspects of the disclosure.

FIG. 7 is another coordinate map of locations of a client device as it moves through a store in accordance with aspects of the disclosure.

FIG. 8 is a diagram of a behavior model in accordance with aspects of the disclosure.

FIG. 9 is a diagram of another behavior model in accordance with aspects of the disclosure.

FIG. 10 is a coordinate map of locations of a client device as it moves through a store in accordance with aspects of the disclosure.

FIG. 11 is a diagram of data in accordance with aspects of the disclosure.

FIGS. 12A and 12B are flow diagrams in accordance with aspects of the disclosure.

### DETAILED DESCRIPTION

The present description relates to generating behavior models describing possible behaviors of a client device in a store and then using content information associated with the behavior models to server content. In one example, a server may receive, from a plurality of participant client devices a time-indexed log for a shopping trip, shopping location information, and purchase information indicating items purchased during the shopping trip. The purchase information may also be received from third parties and not directly from the participants themselves.

In this example, the server may generate behavior models for a particular store. The server may identify a wireless network access point model for the store. The wireless network access point model may map locations in the store to wireless network access point identifiers and signal strengths. The wireless network access point model and the time-indexed log information may be used, for example by the server or a client device, to determine the locations, headings and speeds of a client device in the store.

The server may also access inventory location information for different stores. For example, the inventory location information for one store may include information about the store, such as where products, services, displays or other features are located in the store.

The server then generates a set of behavior models for the store based on the determined locations, headings, and speeds as well as the shopping location information. For each behavior model, the server may also generate content information. The content information may be based on the purchase information associated with the time-indexed log or logs used to generate the particular behavior model. In some examples, the behavior models may be specific to a participant. The server may store the set of behavior models in memory for later use.

The server may then receive a time-indexed logs (or a set of time entries) and shopping location information from a participant client device. The server may identify a wireless network access point model for a store based on the shopping location information. The server then uses the wireless network access point model and the time-indexed log to determine the locations, headings and speeds for the client device.

The server may also identify a set of behavior models based on the location information. In some examples, the server may select a set of behavior models for the store and/or the particular participant associated with the client device. The server may compare the determined locations, headings, and speeds to the set of behavior models. The server may select a behavior model based on the comparison. For example, the server may select the behavior model that most closely matches the determined locations, headings, and speeds.

The server selects content based on the content information associated with the identified behavior model. In some examples, the server may also select content based on the location associated with the last received (or latest in time) log entry. The selected content is then transmitted to the client device for display to the participant.

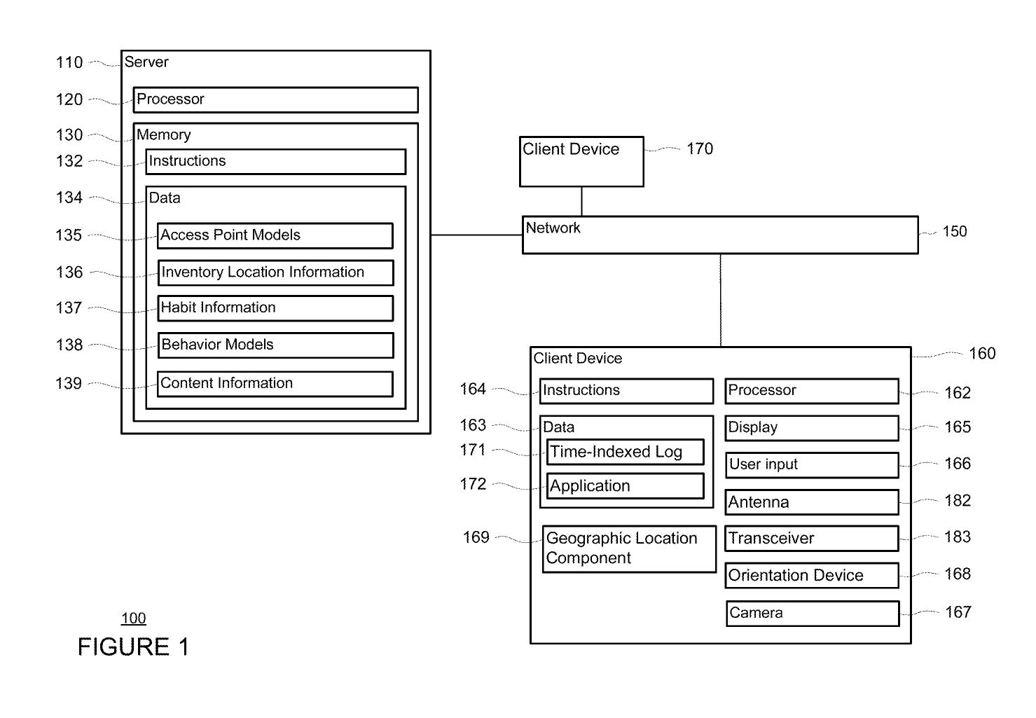

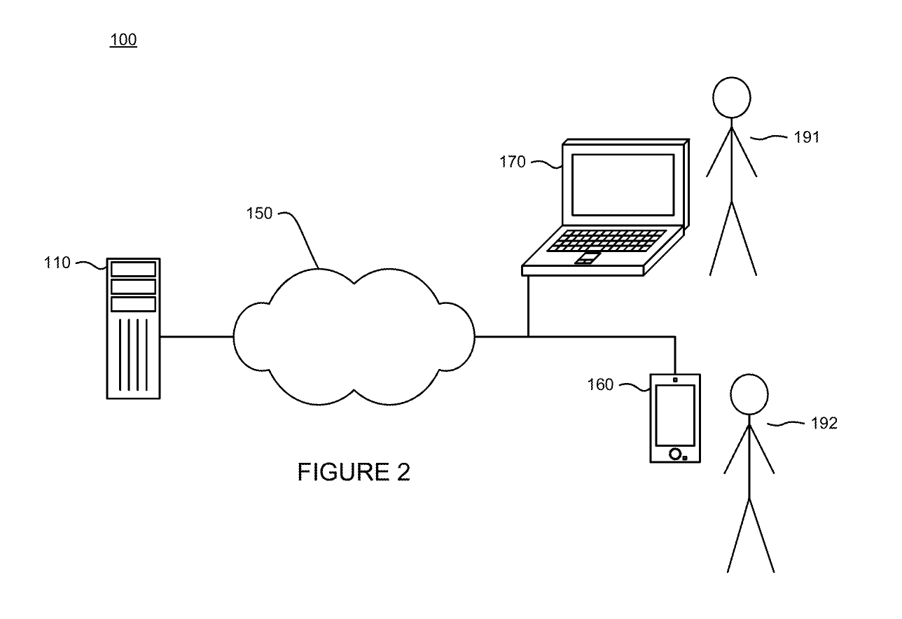

As shown in FIGS. 1-2, a system 100 for use with an implementation includes a computer 110 containing a processor 120, memory 130 and other components typically present in general purpose computers.

The processor 120 may be any conventional processor, such as commercially available CPUs. Alternatively, the processor may be a dedicated controller such as an ASIC or other hardware-based processor. Although FIG. 1 functionally illustrates the processor and memory as being within the same block, it will be understood by those of ordinary skill in the art that the processor and memory may actually comprise multiple processors and memories that may or may not be stored within the same physical housing. For example, memory may be a hard drive or other storage media located in a server farm of a data center. Accordingly, references to a processor, memory, or computer will be understood to include references to a collection of processors, memories or computers that may or may not operate in parallel.

The memory 130 stores information accessible by processor 120, including instructions 132, and data 134 that may be executed or otherwise used by the processor 120. The memory 130 may be of any type capable of storing information accessible by the processor, including a computer-readable medium, or other medium that stores data that may be read with the aid of an electronic device, such as a hard-drive, memory card, ROM, RAM, DVD or other optical disks, as well as other write-capable and read-only memories. Systems and methods may include different combinations of the foregoing, whereby different portions of the instructions and data are stored on different types of media.

The instructions 132 may be any set of instructions to be executed directly (such as machine code) or indirectly (such as scripts) by the processor. For example, the instructions may be stored as computer code on the computer-readable medium. In that regard, the terms “instructions” and “programs” may be used interchangeably herein. The instructions may be stored in object code format for direct processing by the processor, or in any other computer language including scripts or collections of independent source code modules that are interpreted on demand or compiled in advance. Functions, methods and routines of the instructions are explained in more detail below.

The data 134 may be retrieved, stored or modified by processor 120 in accordance with the instructions 132. For instance, although the system and method is not limited by any particular data structure, the data may be stored in computer registers, in a relational database as a table having a plurality of different fields and records, XML documents or flat files. The data may also be formatted in any computer-readable format. By further way of example only, image data may be stored as bitmaps comprised of grids of pixels that are stored in accordance with formats that are compressed or uncompressed, lossless (e.g., BMP) or lossy (e.g., JPEG), and bitmap or vector-based (e.g., SVG), as well as computer instructions for drawing graphics. The data may comprise any information sufficient to identify the relevant information, such as numbers, descriptive text, proprietary codes, references to data stored in other areas of the same memory or different memories (including other network locations) or information that is used by a function to calculate the relevant data.

The computer 110 may be at one node of a network 150 and capable of directly and indirectly communicating with other nodes of the network. For example, the computer 110 may comprise a web server that is capable of communicating with client devices 160 and 170 via network 150 such that server 110 uses network 150 to transmit and present information to a user on display 165 of client device 160. Server 110 may also comprise a plurality of computers that exchange information with different nodes of a network for the purpose of receiving, processing and transmitting data to the client devices. In this instance, the client devices will typically still be at different nodes of the network than any of the computers comprising server 110.

The server 110 and client computers 160 and 170 are capable of direct and indirect communication, such as over network 150. Although only a few computers are depicted in FIGS. 1-2, it should be appreciated that a typical system can include a large number of connected computers, with each different computer being at a different node of the network 150. The network, and intervening nodes, may comprise various configurations and protocols including the Internet, World Wide Web, intranets, virtual private networks, wide area networks, local networks, private networks using communication protocols proprietary to one or more companies, Ethernet, WiFi (such as 802.11, 802.11b, g, n, or other such standards), and HTTP, and various combinations of the foregoing. Such communication may be facilitated by any device capable of transmitting data to and from other computers, such as modems (e.g., dial-up, cable or fiber optic) and wireless interfaces.

Each client device may be configured similarly to the server 110, with a processor, memory and instructions as described above. Each client device 160 or 170 may be a personal computer intended for use by a person 191-192, and have all of the components normally used in connection with a personal computer such as a central processing unit (CPU) 162, memory (e.g., RAM and internal hard drives) storing data 163 and instructions 164, an electronic display 165 (e.g., a monitor having a screen, a touch-screen, a projector, a television, a computer printer or other device that is operable to display information), end user input 166 (e.g., a mouse, keyboard, touch-screen or microphone), camera 167. The client device may also include speakers, a camera, a network interface device, and all of the components used for connecting these elements to one another.

Although the client devices 160 and 170 may each comprise a full-sized personal computer, they may alternatively comprise mobile devices capable of wirelessly exchanging data with a server over a network such as the Internet. By way of example only, client device 160 may be a wireless-enabled PDA, a cellular phone, a tablet PC, or a netbook capable of obtaining information via the Internet. The user may input information using a small keyboard (in the case of a PDA-type phone), a keypad (in the case of a typical cellular phone) or a touch screen (in the case of a PDA).

The client devices may include an antenna 182 and a transceiver 183, which may be used to scan the wireless network spectrum and identify local wireless network signals. For example, many wireless network access points may operate in the 2.4 GHz frequency band and the signals may be based on 802.11, 802.11b, g, n, or other such standards. The access point may transmit and the antenna may receive “beacon” messages according to the aforementioned standards. The antenna may send the beacon messages to the receiver which demodulates the information to identify wireless network access points and associated signal strengths. In one example, these beacon messages may be IEEE 802.11 management frames transmitted by access points to announce themselves to potential wireless network users. These frames may contain Service Set Identifier (“SSID”) information as well as physical layer parameters that assist devices in connecting to the wireless network. The beacon messages may also include additional network access information which also assists devices in accessing the network, including whether the access point is accepting new users, whether the data is encrypted, and which type of authentication is being used, for example, no authentication (open to all), password based, web-portable based, or Media Access Control (“MAC”) address based.

Data collected in accordance with this disclosure may be limited to the information discussed above, for example MAC addresses, SSIDs or other identifiers and signal strengths, and need not contain additional information. For example, information contained in the network traffic or payload data, such as personal information, need not be collected, and in fact, may actually be removed in order to protect the privacy of the wireless network's users.

Client devices 160 and 170 may also include an orientation device 168, such as an accelerometer, gyroscope, compass, or any combination of these, to determine the direction in which the device is oriented. For example, an accelerometer may be used to detect the effect of gravity on the client device measured, for example, in meters per second per second. By way of example only, the client device may use input from the accelerometer to determine the client device's pitch, yaw or roll (or changes thereto) relative to the direction of gravity or a plane perpendicular thereto. In that regard, it will be understood that a client device's provision of orientation data as set forth herein may be provided automatically to the client device.

The orientation data received from the orientation device may be used in various ways. For example, an accelerometer or gyroscope may be used as a pedometer by running an average of the acceleration values to identify which direction is down (towards the Earth). A simple step detector may be constructed by deciding a step has been taken each time the component in the down direction is greater than an empirically-determined threshold. The distance of each step may be approximated by using an approximate stride length or speed of a person.

In this regard, data 163 of client device 160 may store a time-indexed log 171 of measurements from one or more orientation devices and wireless network access point identifiers. For example, the log may include a timestamp, orientation and compass measurements, wireless network access point identifiers (MAC address and/or SSIDs), and signal strengths. Again, this data need not include any payload information, but only that necessary to identify a wireless network access point (or other wireless network identifier) and its associated signal strength. For every unit of time along the route, the client device may record a log entry for that location. For example, a log entry may be recorded periodically, such as every 0.1 seconds. The log data may be transmitted to the server as it is collected or the user may select to transmit the data all at once.

As shown in FIG. 1, the client devices may also include geographic position components, to determine the geographic location of the client device. For example, client device 160 may include a geographic location component (position) 169 such as a GPS receiver. The receiver may be used by the processor of the client device to determine the device's latitude, longitude and altitude position. Thus, as the client device changes location, for example by being physically moved, using information from the GPS receiver, the processor may determine a new current location. The geographic position component may also comprise software for determining the position of the device based on other signals received at the client device, such as signals received from one or more cellular phone towers if the client device or wireless network access points. All or some of this location information may be transmitted by a participating client device to server 110.

Instructions of the client device may also include an application 172. The application may allow the user of the device to participate in a content serving service and to send and receive data with server 110.

Data 134 of server 110 may include a plurality of wireless network access point models 135. For example, each of the wireless network access point models may be associated with a building or a “brick and mortar” store. The models may include the outline of an indoor space such as a building. For example, a footprint as well as include various constraints within the footprint such as walls, windows, doors, and other features as well as measurements or reference data sufficient for the computer to determine the length of a wall or size of a room, etc. The model may also be associated with wireless network access point data describing the expected wireless network access point signals and corresponding signal strengths expected to be detected by a device scanning for such signals at different locations of the map. The expected wireless network access point signals may be specific values or may be a range of values.

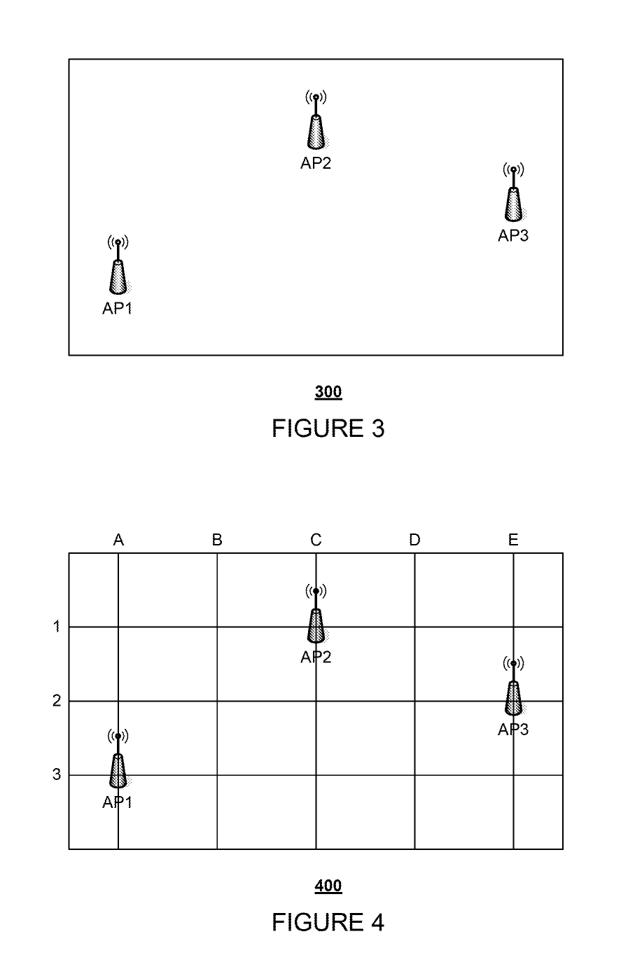

FIG. 3 is a top down view of an example indoor space for a store 300. While the examples used herein include fairly simple open spaces, it will be understood that floor plans (or maps) in accordance with the aspects disclosed herein may be much more complex or simpler based on the attributes of a particular building. The indoor space includes a plurality of wireless access points, AP1, AP2, and AP3, located at various points within store 300. Each of the access points may transmit the beacon messages including identifiers as described above.

FIG. 4 depicts an example coordinate map 400 of the store 300. In this example, the map 400 may include coordinate system (A-E and 1-3) used to identify locations within the indoor space 300. As can be seen, access points A1, A2, and A3 are located at coordinates A3, C2, and E3 respectively.

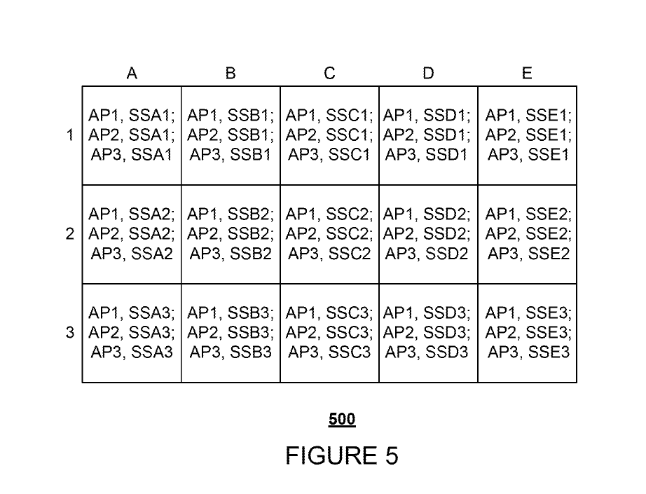

FIG. 5 depicts a table 500 including example wireless network access point model data for the store 300 based on the coordinate system of map 400. Each of the coordinate pair boxes of table 500 is associated with a specific point in the coordinate system of map 400 and includes wireless network access point data. In this example, the calculation of a location of a client device in the indoor space may involve calculating individual latitude and longitude coordinates one at a time or simultaneously.

The wireless network access point model data may be collected by walking devices through the indoor space 300 and collecting scan information. The collected scan information may then be used to generate a set of access point identifiers and corresponding signal strengths for each of the coordinate pair boxes of table 500. For example, at location A3, the table 500 includes data identifying access point AP1 and its corresponding signal strength SSA3 at location A3, access point AP2 and its corresponding signal strength SSA3 at location A3, and access point AP3 and its corresponding signal strength SSA3 at location A3. Similar data is associated with each of the coordinate boxes of table 500. As described in more detail below, the wireless network access point model for an store may be used to determine a client device's location in the store.

While the example of store 300 includes only 3 wireless network access points located on the same level, any number of wireless network access points may be used and may be located at different levels within the same or different indoor spaces. For example, rather than using two coordinates (x, y), the models may have a triplet coordinate system (x, y, z) to identify locations on multiple levels. Thus, different wireless access point models for different indoor locations may include significantly more or less detail than table 500.

In addition, while the wireless network access point model is depicted herein as a coordinate-based map, various other map schemes may also be used. For example, the wireless network access point model may actually comprise a list of locations and corresponding wireless access point identifiers and signal strengths, a topographical or intensity map of wireless access point identifiers and signal strengths, one or more decision or regression trees, etc. As with the coordinate-based maps described above, these models may also be used to determine a client device's location in a store.

The server may also access inventory location information 136 for different stores. For example, the inventory location information for one store may include information about the store, such as where products, services, displays or other features are located in the store. The server may use the inventory location information 136 to identify objects or other features which the client device is or was previously near.

Data 134 of server 110 may include user account information 137 for a plurality of different users. In one example, the user account information may be generated after a user signs up to participate in a content serving service with server 110. Thus, the user account information may include login information such as user names, passwords or passphrases, device identifiers, etc., as well as other information provided by the user such as a home address, email address, or other contact information. In some examples, the user information may include a list of friends and family, co-participants, with which the user has pre-approved to share location and/or other information.

All or some of the user account information may also be stored at the client devices. Certain of the user account information, such as a device identifier, may also be used by a client device to identify the user of the device or the device itself to other devices of network 150.

The server 110 may also store habit information 137 received from the client devices of participating users. This information may be stored with the user account information or at another location, such as a secure server, for increased security. As described in more detail below, once the user has signed up to participate, the client device may store information about the user's habits such as items the user has purchased, items for which the user indicates an interest in purchasing, the frequency with which the user visits a store or makes a purchase, information about whether any of the user's co-participants were in close proximity to the user at the time of a purchase made by the user, as well as information about how a client device moved through a store when an item is purchased. This information about how a client device moves may include or be based on the time-indexed log information and other location information provided by a participating user.

The server 110 may also store behavior models 138 describing shopping behaviors (speed, directions, paths, patterns, stops, etc.) and content information. As described in more detail below, the behaviors of a client device may be compared to each of the models of the set of behavior models to determine which behavior model the client device's behaviors fit best. The server may then use the content information associated with the identified behavior model to identify content.

These behavior models may be very generic (for all participants and all stores), specific to the type of store (a set of behavior models for sporting good stores, department stores, supermarkets, etc.), store or chain specific (REI, Walmart, etc.), or user specific (a set of behavior models for each user). Thus, in some examples, for each user account, the server may generate a user behavior model indicating the shopping behaviors and tendencies of that user for a plurality of different stores or chains. As described in more detail below, the behavior models may be generated based on the habit information described above.

The content information may be used to select and serve content. For example, if the behavior model is for a specific store or type of store (for all users or a particular users) the content information may include the types of products or services participants may purchase at the store as well as complementary goods (shampoo and conditioner, coffee and creamer, lamp and light bulb, etc.) or competitive items (Ford truck vs. Chevrolet truck).

In one example, the set of behavior models may include a single threshold value, for example, whether the client device moving faster or slower than a particular speed. In this example, the set may include two modes; one model describing speeds above the threshold value and another model describing speeds below the threshold value. In another example, the behavior models may be much more detailed. The set of behavior models may include possible paths for a particular store and the speeds, stops, and direction (headings) along the paths. In this example, the set of behavior models may include a plurality of behavior models describing behaviors of shoppers (the browser, the list-follower, the single-item purchaser). In this regard, the behavior models may indicate whether a participant is in a hurry, whether the participant is lost, whether the participant has time to browse, whether the participant has a strong interest in purchasing a particular item, etc.

The behavior models may be used to determine if the participant is likely to spend a lot of money or a little bit of money, purchase a few or many items, spend more or less time in the store, is familiar with the store, etc. In other words, the server may determine whether the participant is likely to be browsing, following a list, buying only a few particular items, etc. and user the associated content information to serve content the participant in which the participant may actually be interested. For example, a participant exhibiting a hurried behavior may have entered the indoor space with intent to purchase a single item or a few items. Such a participant likely is not interested in viewing advertisements or purchasing additional items, but may be interested in a generic coupon for the store. In another example, a participant exhibiting a browsing behavior may have entered the store without intention of purchasing any particular item. Such a participant may be interested in viewing advertisements for items sold in the indoor space and browsing around the store to consider purchasing the advertised items. Meanwhile, a participant exhibiting a scavenging behavior may have entered the indoor space with a shopping list of several items to purchase. Such a participant may be open to viewing advertisements for items similar to the items on the user's shopping list. A participant reflecting an interested behavior may have found an item that he or she was searching for in the store. Such a participant may be very strongly inclined to purchase the item, or another item similar or complementary to the item. Thus, the behavior models describing such behaviors may be associated with different content information.

In some examples, each set of behavior models may include behavior models for various ranges of speeds or headings. In one example, the behavior model may include a threshold, for example, is the speed of a client device greater than or equal to 3 feet per second. In another example, a model may include information classifying speeds of 2 feet per second (ft/sec) or slower as “slow speeds,” classifying speeds between 2 and 5 (ft/sec) as “moderate speeds”, and classifying speeds 5 (ft/sec) and faster as “fast speeds.” This may also include information for classifying speeds near 0 feet per second as stationary speeds. Similar classifications may be used for headings: small changes (e.g., 30 degrees or less), moderate changes (e.g., between 40 and 140 degrees), large changes (e.g., between 150 and 180 degrees), etc.

The server 110 may also access content information 139. The content data may include for example, images, text, etc. used to generate information for display to a user. In some examples, the content may include advertisements and/or coupons. The content may be classified into categories or types which may be readily identified from the content information associated with the behavior models. For example, some categories of content may be more relevant where a client device travelling quickly as opposed to when the same device is merely meandering through a store. If a participant is traveling through a store quickly he may have a particular purpose (to purchase only a few specific items) whereas a participant who travels more slowly through a store may be simply browsing and could be more likely to purchase different items. Similarly, different categories of content may be served if a client device is stationary for a period of time while located proximate to a particular product type versus if the same client device is moved past or through the location more quickly. In yet another example, the content may be selected, for example, by identifying categories of content associated with products which are located near a next predicted location of the client device. In this example, the server may determine that the client device is likely to be at a particular when content is served. The server uses the predicted location to identify products, services, or displays presented at the predicted location to select content.

The client device may also receive and store data provided by the server 110, including, for example, all or portions of the wireless network access point models, inventory location information, user account information, behavior models, and content. Thus, a client device may also perform all or some of the functions identified below as being performed by a server.

In addition to the operations described below and illustrated in the figures, various operations will now be described. It should also be understood that the following operations do not have to be performed in the precise order described below. Rather, various steps may be handled in a different order or simultaneously. Steps may also be omitted or added unless otherwise stated herein.

A user may sign up or opt to participate (a “participant”) in a content serving service as described above. Participants may be required to take an affirmative step in order to select or “opt-in” to participate. For example, participants may be required to sign in to a service before any information is transmitted between the participant's client device and the server. Participants may also be provided with the opportunity to cease participation temporarily or permanently at any time.

After opting to participate, the participant's client device may record information about the participant's shopping habits. The participant may activate an application which allows the client device to record information when the participant is shopping. In this regard, the participant may also deactivate the application when the participant does not want to share information with the server 110.

In one example, the client device may record a time-indexed log 171. The client device may also record location information, for example determined by information from the geographic position component 169. Again this data may be transmitted to the server as it is collected or the participant may select to transmit the data once the participant has finished walking through the indoor space. This data may be recorded and transmitted to the server 110 for a plurality of shopping trips.

The client device may also transmit purchase information to the server 110. The purchase information may indicate when and where an item was purchased, as well as the quantity of the item purchased and the cost of the item when purchased (including, for example, both a retail cost and a discounted cost if the item was purchased while discounted). For example, if the client device is used to pay for a purchase, the purchased items may be automatically transmitted to the server by the application. In another example, the participant may manually enter the purchased items and submit them to the server. In yet another example, the purchased items may be reported to the server 110 by a third party, for example, if the user uses a particular coupon provided by the content serving service.

The log, location, and purchase information from a plurality of participants may be received by server 110. The server 110 may process the information to generate or supplement a model of a set of behavior models.

In one example, the server may use the location information to identify the stores visited by each participant. The modeling may consider each store's geographic location, type (e.g., grocery, electronics store, department store, etc.), whether the store is a chain (e.g., REI, Sears, Best Buy, etc.), etc. The modeling may also consider the frequency with which this or all participants visit a particular store or particular type of store and makes purchases (e.g., every Sunday, four times a week, only once).

Once the server 110 has identified a particular store from the received data for a particular participant, the server may identify a wireless network access point model for the store. The server may then use the wireless access point model to identify the locations of the client device from the time indexed log. This may include comparing the wireless network access point identifiers and signal strengths of the time-indexed log to the model as well as using the data from one or more orientation devices to increase the accuracy of the determination. These locations may be “strung” together in timestamp order to identify the client device's path through the store as well as the client device's speeds and headings along that path.

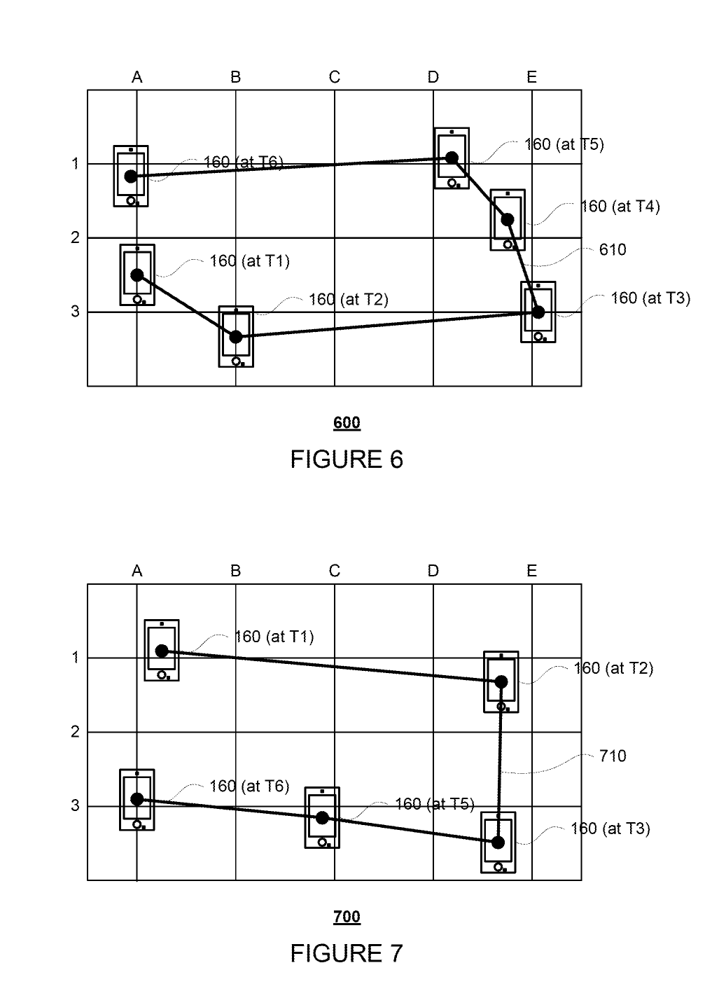

For example, coordinate map 600 of FIG. 6 depicts a plurality of locations for client device 160 at different timestamps (T1-T6) on a first shopping trip in store 300. In this example, timestamp T1 is the first timestamps in time and T6 is the last or latest timestamp in time. These locations make up a path 610. Each of the timestamps may be the same time distance apart, thus, between timestamp T3 and T4, the client device may have moved slower than between timestamps T5 and T1. Coordinate map 700 of FIG. 7 depicts a plurality of locations for client device 160 at different timestamps (T7-T11) on a second shopping trip in store 300. In this example, timestamp T7 is the first timestamps in time and T11 is the last or latest timestamp in time. These locations make up a path 710. Each of the timestamps may be the same time distance apart, thus, between timestamp T10 and T11, the client device may have moved slower than between timestamps T7 and T8.

The path data and for a plurality of different participants may be used to generate the behavior models. For example, a behavior model may be based on a single shopping trip for a single participant, a plurality of shopping trips for single participant, or a plurality of shopping trips for a plurality of participants. In some examples, behavior models for a particular participant may be constructed based on the shopping habits of other participants that have also given permission for their data to be used as such. For instance, the information included in the behavior models may be based on a distribution and range of speeds, headings, and paths exhibited any number of participants, including participants other than the participant(s) of the client device.

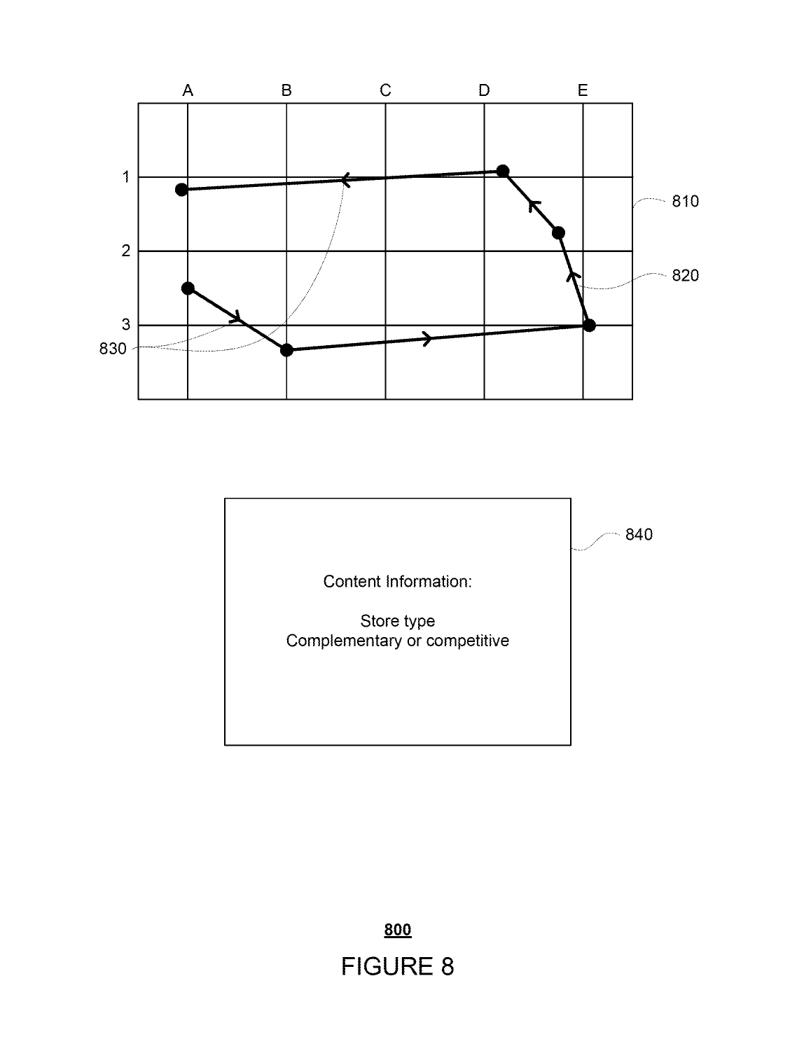

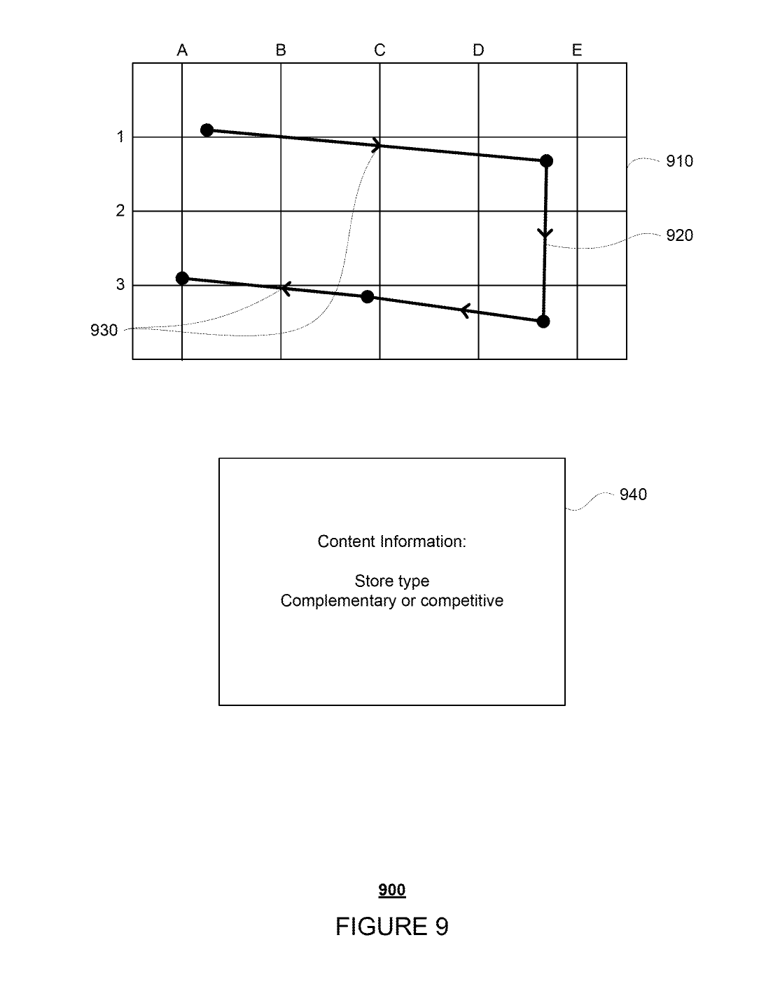

For example, FIG. 8 depicts a behavior model 800 for store 300 based on the information of FIG. 6. In this example, coordinate map 810 includes a path 820 having a plurality of headings 830. The behavior model 800 may also include information such average speeds, ranges of speeds, specific stopping points, etc. FIG. 9 depicts a behavior model 900 for store 300 based on the information of FIG. 7. In this example, coordinate map 910 includes a path 920 having a plurality of headings 930. And the behavior models 800 and 900 may also include information such average speeds, ranges of speeds, specific stopping points, etc.

The received purchase information may also be used to generate the content information described above. For example, the content information may be based on the types of items purchased during the shopping trip or trips used to generate the models (e.g., groceries, electronics, appliances). The content information may also be based on the quantity purchased, the cost of the items, and the time of the purchase (or how long the participant spent in the store before making the purchase).

The content information may also be related to the types of behavior indicated by the behavior models. In the example of a client device exhibiting a hurried behavior, the server may determine that the participant has little interest in receiving advertisements for competitive items, as the user has likely already decided on what item to purchase. Similarly, a hurried user has a strong interest in receiving advertisements for complementary items, as the hurried user may otherwise forget to purchase a necessary complementary item. For example, a hurried user who stops briefly at the shampoo aisle may also be interested in conditioner. Thus, the behavior model indicating a hurried customer may be associated with content information suggesting complementary items.

Returning to FIG. 8, the behavior model 800 also includes content information 840 that may be used by the server to select content. This information may be based on the types of products purchased by the participant during the shopping trip of FIG. 6. In this example, the content information includes the type of store (or the type of products sold in the store 300) as well as information indicating complementary content. Similarly, in FIG. 9, the content information includes the type of store (or the type of products sold in the store 300) as well as information indicating competitive content.

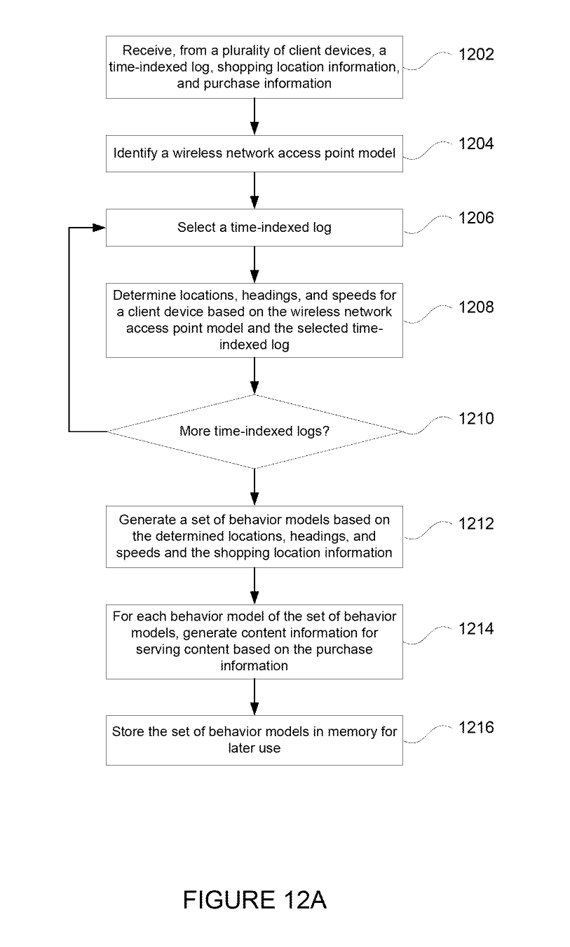

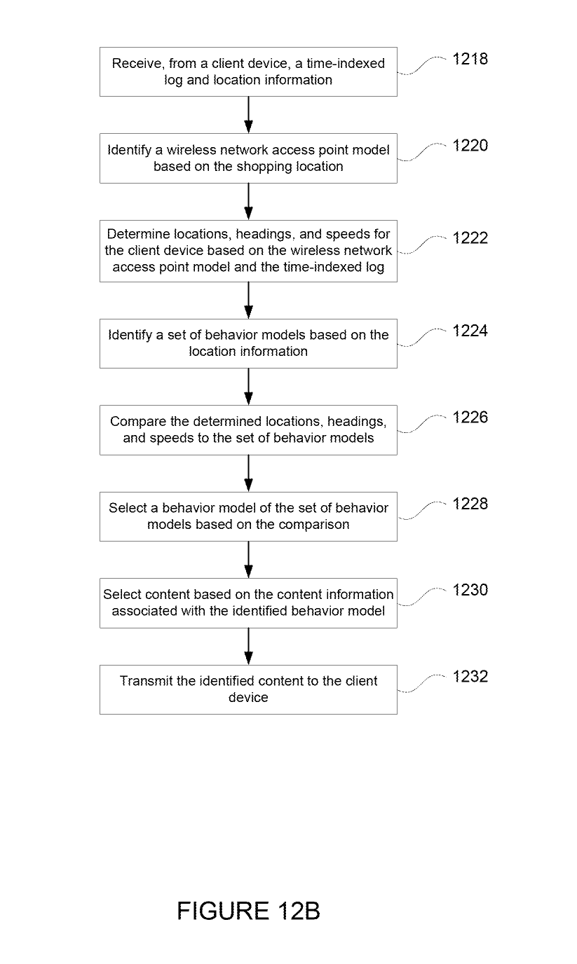

The flow diagram of FIG. 12A is an example of some of the aspects of generating the behavior models described above. It will be understood that the flow diagram of FIG. 12A is merely an example of one possible series of steps. However, various other combinations and/or arrangements may also be used. In this example, at block 1202, a server receives, from a plurality of participant client devices a time-indexed log, shopping location information, and purchase information. As noted above, the purchase information may also be received from third parties and not directly from the participants themselves.

In this example, the server may be generating behavior models for a particular store. The server identifies a wireless network access point model for the store at block 1204. The server selects a time-indexed log associated with shopping location information which indicates that the time-indexed log was collected for the store at block 1206.

The server then uses the wireless network access point model and the selected time-indexed log to determine the locations, headings and speeds for a client device in the store at block 1208. At block 1210, if there are additional time-indexed logs for the store, the server may return to block 1206 to process additional time-indexed logs. If there are no additional time-indexed logs to be processed, the server may continue to block 1212 and generate a set of behavior models for the store based on the determined locations, headings, and speeds as well as the shopping location information.

For each behavior model, the server may also generate content information at block 1214. The content information may be based on the purchase information associated with the time-indexed logs used to generate the particular behavior model. The server may store the set of behavior models in memory for later use at block 1216. As noted above, rather than generating a set of behavior models for a particular store, the flow diagram of FIG. 12A may also be used to generate a set of behavior models for a particular participant, for example, where the time-indexed logs, shopping location information, and purchase information are received from client devices associated with the same participant. FIG. 12B will be discussed in more detail below.

Again, when the participant is going on a shopping trip, he or she may activate the application. As noted above, the client device may then record a time-indexed log of measurements from the one or more orientation devices. The client device may also record location information, for example determined by information from the geographic position component. Again this data may be transmitted to the server as it is collected.

The server 110 may receive this data from a client device and use it to determine how the client device is currently moving through the store. For example, the server may use the location information to identify a wireless network access point model for the store. The log information may then be compared to the wireless access point model to estimate the behaviors of the client device. Again, this may include comparing the wireless network access point identifiers and signal strengths of the time-indexed log to the model as well as using the data from one or more orientation devices to increase the accuracy of the determination. The behaviors may include specific locations of the client device in the store, the heading of the client device, the path of the client device, how fast the client device is moving through each part of the store, whether the client device stopped moving at a particular location for a period of time, etc.

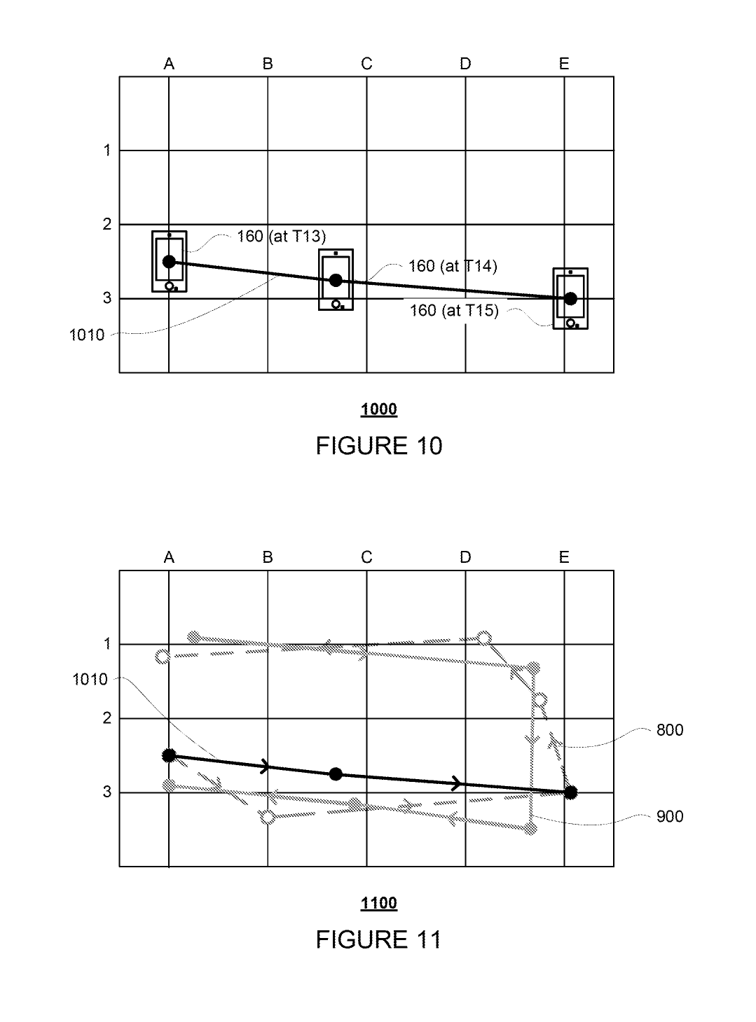

For example, server 110 may receive information from client device 160 for a third shopping trip at store 300. The server may determine the locations and the path of the client device. Coordinate map 1000 of FIG. 10 depicts a plurality of locations for client device 160 at different timestamps (T13-T15) for the third shopping trip. These timestamps form a path 1010. In this example, timestamp T13 is the first timestamp in time and T15 is the last or latest timestamp in time. Thus, the location at T15 may be the current (or most up-to-date location for client device 160.

The server may also use the information received from the client device to identify specific set of a behavior models. For example, the server may receive information identifying the participant's user account and access the participant's personal set of behavior models. In another example, the server may use the location information to identify a set of behavior models for the store at which the client device currently is or this type of store. Returning to the example of FIG. 10, the server 110 may identify a set of behavior models for store 300 including behavior model 800 and behavior model 900.

Once the server 110 has identified the relevant set of behavior models, the server may compare the current behaviors of the client device to the identified set of behavior models to determine the behavior model most similar to the current behaviors. For example, coordinate map 1100 of FIG. 11 depicts a visual comparison of path 1010 to behavior models 800 and 900. The server may identify either behavior model 800 or behavior model 900 as the most similar depending on the characteristics of the behavior models and the path 1010.

The server may select content based on the content information associated with the identified behavior model as well as the current location of the client device. For example, the server may use the estimated location at the latest timestamp (in the example of FIG. 10, T15) as the current location of the client device. The server may then determine what object, product, etc. the client device is proximate to based on the wireless access point model for store 300. Using this information, combined with the content information of the identified behavior model, the server may select content from content 138.

Returning to the example of FIG. 11, the server 110 may determine that the information associated with path 1010 is closer to behavior model 900 than behavior model 800. The content information associated with behavior model includes an electronic store type and competitive goods. The server may also determine that at time T15, the client device is near a plasma television display by Electronics Company A. The server may select content based on all of this information, and, for example, may provide a coupon or advertisement for LCD televisions by Electronics Company B.

In another example, the server 110 may determine that the information associated with path 1010 is closer to behavior model 800 than behavior model 900. The content information associated with behavior model includes an electronic store type and complementary goods. The server may determine that at time T15, the client device is near a plasma television display. The server may select content based on all of this information, and, for example, may provide a coupon or advertisement for a wall mounting system for a television.

The selected content may be transmitted to the client device for display to the participant. Any number of notifications can be used. For example, the client device may give an audible notification when the content is received and display a text message. In another example, the content may be sent to the user for a later shopping trip. In this example, the user account information may include the user's email, and the content, for example a coupon for another shopping trip, may be emailed to the user's email address.

The flow diagram of FIG. 12B is an example of some of the aspects of selecting and providing content described above. It will be understood that the flow diagram of FIG. 12B is merely an example of one possible series of steps performed by a server. However, various other combinations and/or arrangements, for example as noted above where all or some of the steps are performed by a client device, may also be used. In this example, at block 1218, a server receives a time-indexed log (or a set of time entries) and shopping location information from a participant client device. The server identifies a wireless network access point model based on the shopping location information at block 1220. The server then uses the wireless network access point model and the time-indexed log to determine the locations, headings and speeds for the client device at block 1222.

The server also identifies a set of behavior models based on the location information at block 1224. In some examples, the server may select a set of behavior models for the particular participant associated with the client device. The server compares the determined locations, headings, and speeds to the set of behavior models at block 1226. The server selects a behavior model based on the comparison at block 1228. For example, the server may select the behavior model that most closely matches the determined locations, headings, and speeds.

The server selects content based on the content information associated with the identified behavior model at block 1230. In some examples, the server may also select content based on the location associated with the last received (or latest in time) log entry. The selected content is transmitted to the client device at block 1232.

In one example, before selecting the content may involve determining how much and/or how often content is provided to a client device. This information may be included in a participant's user account information and set by the participant. Alternatively, the frequency information may be included in the content information associated with a behavior model. This may be important because participants exhibiting different behaviors may be interested in receiving a different number of advertisements. For example, a hurried participant may want little or no content, as this participant likely has little interest in viewing advertisements or coupons while hurrying through the store. In another example, the browsing participant may like to view a greater number of advertisements or coupons, as the participant likely has great interest in viewing several advertisements while browsing items in the indoor space.

In one example, in conjunction with selecting content to provide to a client device, the server may also consider the participant's home location. The home location may be useful in determining a participant's familiarity with the layout or floor plan of a location, as a participant may visit locations far from home with much less frequency and have less familiarity with the layouts of the locations far from home. In this example, the client device's behaviors may indicate that the participant is moving slowly through a store. If the store is one which the participant has not visited in the past or is particularly far from the participant's home address, the server may serve content to the client device in order to guide the participant through the store. In addition, the fact that a client device (or a participant) is in an unfamiliar location may be used to adjust the speed thresholds. In this example, for example a participant may be more likely to move slower even if he or she is making a quick shopping trip to buy only a few items.

As noted above, the user account information may include a list of friends and family, co-participants, with which the user has pre-approved to share location and/or other information. This information may also be used to train the behavior models. For example, when using the received data to train the model, the server may identify shopping habits when two particular co-participants are in close proximity to one another. This information may be useful for identifying items (or a category of items) that a participant may be inclined to purchase in the future when standing close to proximity to a particular pre-approved co-participant. Accordingly, this information may be used to supplement a model for one or the two co-participants or to generate a model for when these two co-participants are in close-proximity. For example, Jane may be more willing to spend when she is in close proximity to Sarah, but less willing to spend when she is in close proximity to Paul.

These models may then be used to serve content as described above. For example, if the server may also determine whether it is receiving information from these pre-approved participants at the same time as the client device is sending information. If so, the server may determine whether any of the pre-approved co-participants are in close proximity (same store, same floor, or same aisle) to the client device and use this information to select a behavior model and serve content. Using the example, above, the server may provide Jane with advertisements for more expensive items when she is with Sarah and coupons for less expensive items when she is with Paul. Alternatively, the server may provide Jane with advertisements for less expensive items when she is with Paul and coupons for more expensive items when she is with Jane.

Although the examples above depict the processing of log information to select content occurring primarily at the server, aspects of the processing may also be performed at the client device. For example, when the user activates the application, the application may send a request including the location information to the server. In response, the serve may send all or part of the wireless network access point model for the store. In this regard, the client device may do the processing to determine its own current location and behavior information using the wireless network access point model. In this regard, the client device may transmit the behavior information to the server (as opposed to the “raw” log information). In another example, in addition to receiving the wireless network access point model from the server, the client device may also receive all or part of the behavior models. In this example, the client device may use the received behavior models to classify the current behavior of the client device and send the classification information to the server.

As these and other variations and combinations of the features discussed above can be utilized without departing from the systems and methods as defined by the claims, the foregoing description of exemplary implementations should be taken by way of illustration rather than by way of limitation of the disclosure as defined by the claims. It will also be understood that the provision of examples (as well as clauses phrased as “such as,” “e.g.”, “including” and the like) should not be interpreted as limiting the disclosure to the specific examples; rather, the examples are intended to illustrate only some of many possible aspects.

1. A method for generating a set of behavior models for a store, the method comprising:
receiving, by one or more processors, a plurality of time-indexed logs, each time-indexed log of the plurality of being associated with the store and with purchase information describing one or more items purchased by a participant during a shopping trip, and each time-indexed log of the plurality of time-indexed logs including one or more wireless network access point identifiers and signal strengths;
identifying, by the one or more processors, a wireless network access point model for the store, the wireless network access point model mapping locations in the store to wireless network access point identifiers and signal strengths;
for each given time-indexed log of the plurality of time-indexed logs, determining, by the one or more processors, one or more locations, headings, and speeds based on the wireless network access point model;
generating, by one or more processors, the set of behavior models for the store based on the one or more determined locations, headings, and speeds, wherein at least one behavior model of the set of behavior models is generated from time indexed logs of two different participants and includes a speed threshold value;
for the at least one behavior model, generating, by the one or more processors, first and second content information for serving content based on the purchase information associated with the time indexed logs used to generate the at least one behavior model, the first content information being associated with speed values greater than the speed threshold value and the second content information being associated with speed values less than the speed threshold value; and
storing, by the one or more processors, the set of behavior models for the store in memory for later use.

2. The method of claim 1, wherein each of the plurality of time-indexed logs is received from one or more client devices associated with a particular participant, and the method further comprises associating the set of behavior models with an account for the particular user.

3. The method of claim 1, wherein each time-indexed log of the plurality of time-indexed logs further includes measurements from one or more orientation devices, and wherein determining the locations, headings, and speeds for each given time-indexed log of the plurality of time-indexed logs is further based on the measurements from the one or more orientation devices for the given time-indexed log.

4. The method of claim 1, further comprising:
receiving a second plurality of time-indexed logs, each time-indexed log of the second plurality being associated with a second store and purchase information describing items purchased by a participant during a shopping trip to the second store, and each time-indexed log of the plurality of second time-indexed logs including one or more wireless network access point identifiers and signal strengths, wherein the second store is different from the store;
identifying a second wireless network access point model for the second store, the second wireless network access point model mapping locations in the second store to wireless network access point identifiers and signal strengths;
for each given time-indexed log of the plurality of second time-indexed logs, determining one or more second locations, second headings, and second speeds based on the second wireless network access point model;
generating a second set of behavior models for the second store based on the one or more determined second locations, second headings, and second speeds;
for each given behavior model of the second set of behavior models for the store, generating second content information for serving content based on the second purchase information associated with the time-indexed log or time-indexed logs of the plurality of second time-indexed logs used to generate the given behavior model; and
storing the second set of behavior models for the store in the memory for later use.

5. The method of claim 4, further comprising:
receiving, from a first client device, location information;
identifying, from the stored sets of behavior models, the second set of behavior models based on the received location information; and
identifying the second wireless network access point model based on the received location information.

6. The method of claim 5, further comprising:
receiving, from the first client device, a set of time-indexed log entries including wireless network access point identifiers and signal strengths;
after identifying the second wireless network access point model based on the received location information, determining one or more third locations, one or more third headings, and one or more third speeds based on the second wireless network access point model;
identifying a most closely matching behavior model of the second set of behavior models based on the determined one or more third locations, one or more third headings, and one or more third speeds;
identifying content for display to a user based on the second content information associated with the most closely matching behavior model; and
transmitting the identified content to the first client device.

7. A method for selecting content based on physical activity associated with a client device, the method comprising:
receiving, by one or more processors, from the client device, location information;
selecting, by the one or more processors, a set of behavior models from a plurality of stored sets of behavior models based on the received location information, each behavior model of the plurality of behavior models describing behavior of a client device during a shopping event and being associated with content information used to identify content for display to a user;
identifying, by the one or more processors, from a plurality of wireless network access point models, a wireless network access point model based on the received location information, each wireless network access point model of the plurality of wireless network access point models mapping locations in a respective store to wireless network access point identifiers and signal strengths;
receiving, by the one or more processors, from the first client device, a set of time-indexed log entries including one or more wireless network access point identifiers and signal strengths;
determining, by the one or more processors, one or more locations, one or more headings, and one or more speeds based on the identified wireless network access point model;
selecting, by the one or more processors, a most closely matching behavior model of the set of behavior models based on the determined one or more locations, one or more headings, and one or more speeds;
comparing, by the one or more processors, the one or more speeds to a speed threshold value associated with most closely matching behavior model;
identifying, by the one or more processors, content for display to a user of the client device based on the content information associated with the most closely matching behavior model and the comparison; and
transmitting, by the one or more processors, the identified content to the client device.

8. The method of claim 7, wherein identifying the set of behavior models is further based on account information associated with the user of the client device.

9. The method of claim 7, wherein identifying the content is further based on account information associated with the user of the client device indicating how much content the user of the client device wants to receive.

10. (canceled)

11. The method of claim 7, further comprising:
after identifying content, generating an advertisement from the identified content; and
transmitting the advertisement to the client device.

12. A device for generating a set of behavior models for a store, the device comprising:
memory storing instructions;
one or more processors configured to execute the instructions in order to:
receive a plurality of time-indexed logs, each time-indexed log of the plurality of being associated with the store and with purchase information describing one or more items purchased by a participant during a shopping trip, and each time-indexed log of the plurality of time-indexed logs including one or more wireless network access point identifiers and signal strengths;
identify a wireless network access point model for the store, the wireless network access point model mapping locations in the store to wireless network access point identifiers and signal strengths;
for each given time-indexed log of the plurality of time-indexed logs, determine one or more locations, headings, and speeds based on the wireless network access point model;
generate the set of behavior models for the store based on the one or more determined locations, headings, and speeds, wherein at least one behavior model of the set of behavior models is generated from time indexed logs of two different participants and includes a speed threshold value;
for the at least one behavior model, generate first and second content information for serving content based on the purchase information associated the time indexed logs used to generate the at least one behavior model, the first content information being associated with speed values greater than the speed threshold value and the second content information being associated with speed values less than the speed threshold value; and
store the set of behavior models for the store in the memory for later use.

13. The device of claim 12, wherein each of the plurality of time-indexed logs is received from one or more client devices associated with a particular participant, and the processor further associates the set of behavior models with an account for the particular user.

14. The device of claim 12, wherein each time-indexed log of the plurality of time-indexed logs further includes measurements from one or more orientation devices, and wherein the processor further determines the locations, headings, and speeds for each given time-indexed log of the plurality of time-indexed logs is further based on the measurements from the one or more orientation devices for the given time-indexed log.

15. The device of claim 12, wherein the processor further executes the instructions in order to:
receive a second plurality of time-indexed logs, each time-indexed log of the second plurality being associated with a second store and purchase information describing items purchased by a participant during a shopping trip to the second store, and each time-indexed log of the plurality of second time-indexed logs including one or more wireless network access point identifiers and signal strengths, wherein the second store is different from the store;
identify a second wireless network access point model for the second store, the second wireless network access point model mapping locations in the second store to wireless network access point identifiers and signal strengths;
for each given time-indexed log of the plurality of second time-indexed logs, determine one or more second locations, second headings, and second speeds based on the second wireless network access point model;
generate a second set of behavior models for the second store based on the one or more determined second locations, second headings, and second speeds;
for each given behavior model of the second set of behavior models for the store, generate second content information for serving content based on the second purchase information associated with the time-indexed log or time-indexed logs of the plurality of second time-indexed logs used to generate the given behavior model; and
store the second set of behavior models for the store in the memory for later use.

16. The device of claim 15, wherein the processor further executes the instructions in order to:
receive, from a first client device, location information;
identify, from the stored sets of behavior models, the second set of behavior models based on the received location information; and
identify the second wireless network access point model based on the received location information.

17. The device of claim 16, wherein the processor further executes the instructions in order to:
receive, from the first client device, a set of time-indexed log entries including wireless network access point identifiers and signal strengths;
after identifying the second wireless network access point model based on the received location information, determine one or more third locations, one or more third headings, and one or more third speeds based on the second wireless network access point model;
identify a most closely matching behavior model of the second set of behavior models based on the determined one or more third locations, one or more third headings, and one or more third speeds;
identify content for display to a user based on the second content information associated with the most closely matching behavior model;
transmit the identified content to the first client device.

18. A device for selecting content based on physical activity associated with of a client device, the device comprising:
memory storing instructions;
one or more processors configured to execute the instructions in order to:
receive, from the client device, location information;
identifying a set of behavior models from a plurality of stored sets of behavior models based on the received location information, each behavior model of the plurality of behavior models describing behavior of a client device during a shopping event and being associated with content information used to identify content for display to a user;
identify, from a plurality of wireless network access point models, a wireless network access point model based on the received location information, each wireless network access point model of the plurality of wireless network access point models mapping locations in a respective store to wireless network access point identifiers and signal strengths;
receive, from the first client device, a set of time-indexed log entries including one or more wireless network access point identifiers and signal strengths;
determine one or more locations, one or more headings, and one or more speeds based on the identified wireless network access point model;
select a most closely matching behavior model of the second set of behavior models based on the determined one or more locations, one or more headings, and one or more speeds;
comparing the one or more speeds to a speed threshold value associated with the behavior model;
identify content for display to a user of the client device based on the content information associated with the most closely matching behavior model and the comparison; and
transmit the identified content to the client device.

19. The device of claim 18, wherein the processor further executes the instructions in order to identify the set of behavior models based on account information associated with the user of the client device.

20. The device of claim 18, wherein the processor further executes the instructions in order to identify the content based on account information associated with the user of the client device indicating how much content the user of the client device wants to receive.

21. The device of claim 18, wherein the processor further executes the instructions in order to identify the content based on account information associated with the user of the client device indicating how much content the user of the client device wants to receive.

22. The device of claim 18, wherein the processor further executes the instructions in order to:
after identifying content, generate an advertisement from the identified content; and
transmit the advertisement to the client device.

23. A tangible, non-transitory computer-readable storage medium on which computer readable instructions of a program are stored, the instructions, when executed by a processor, cause the processor to perform a method of generating a set of behavior models for a store, the method comprising:
receiving a plurality of time-indexed logs, each time-indexed log of the plurality of being associated with the store and with purchase information describing one or more items purchased by a participant during a shopping trip, and each time-indexed log of the plurality of time-indexed logs including one or more wireless network access point identifiers and signal strengths;
identifying a wireless network access point model for the store, the wireless network access point model mapping locations in the store to wireless network access point identifiers and signal strengths;
for each given time-indexed log of the plurality of time-indexed logs, determining one or more locations, headings, and speeds based on the wireless network access point model;
generating the set of behavior models for the store based on the one or more determined locations, headings, and speeds, wherein at least one behavior model of the set of behavior models is generated from time indexed logs of two different participants and includes a speed threshold value;
for the at least one behavior model, generating first and second content information for serving content based on the purchase information associated with the time indexed logs used to generate the at least one behavior model, the first content information being associated with speed values greater than the speed threshold value and the second content information being associated with speed values less than the speed threshold value; and
storing the set of behavior models for the store in memory for later use.

24. A tangible, non-transitory computer-readable storage medium on which computer readable instructions of a program are stored, the instructions, when executed by a processor, cause the processor to perform a method of selecting content based on physical activity associated with of a client device, the method comprising:
receiving, from the client device, location information;
identifying a set of behavior models from a plurality of stored sets of behavior models based on the received location information, each behavior model of the plurality of behavior models describing behavior of a client device during a shopping event and being associated with content information used to identify content for display to a user;
identifying, from a plurality of wireless network access point models, a wireless network access point model based on the received location information, each wireless network access point model of the plurality of wireless network access point models mapping locations in a respective store to wireless network access point identifiers and signal strengths;
receiving, from the first client device, a set of time-indexed log entries including one or more wireless network access point identifiers and signal strengths;
determining one or more locations, one or more headings, and one or more speeds based on the identified wireless network access point model;
selecting a most closely matching behavior model of the second set of behavior models based on the determined one or more locations, one or more headings, and one or more speeds;
comparing the one or more speeds to a speed threshold value associated with the behavior model;
identifying content for display to a user of the client device based on the content information associated with the most closely matching behavior model and the comparison; and
transmitting the identified content to the client device.

25. The method of claim 7, wherein the location information describes a type of store and the set of behavior models is selected further based on the type of store.
